(19) United States
(12) Patent Application Publication
(10) Pub. No.: US 2009/0296968 A1
(43) Pub. Date: Dec. 3, 2009

(54) Maintenance station for hearing aid

(75) Inventors: Fan Wu, Scottsdale, AZ (US); Samuel L. Thomasson, Gilbert, AZ (US)

Correspondence Address: Paul F. Wille, 6407 East Clinton St., Scottsdale, AZ, 85254, US

(73) Assignee: Zounds, Inc., Mesa, AZ (US)

(21) Appl. No.: 12/154,963

(22) Filed: May 28, 2008

(51) Int. Cl. H04R 25/00

(52) U.S. Cl. 381/323

(57) ABSTRACT

A maintenance station includes means for disinfecting, drying, recharging, and communicating with one or more hearing aids using light. In a preferred embodiment of the invention, a fluorescent lamp is primarily for disinfecting a hearing aid, an incandescent lamp is primarily for recharging a hearing aid, and a light emitting diode is primarily for communicating with a hearing aid. All power dissipated within the station aids in drying the hearing aids within.

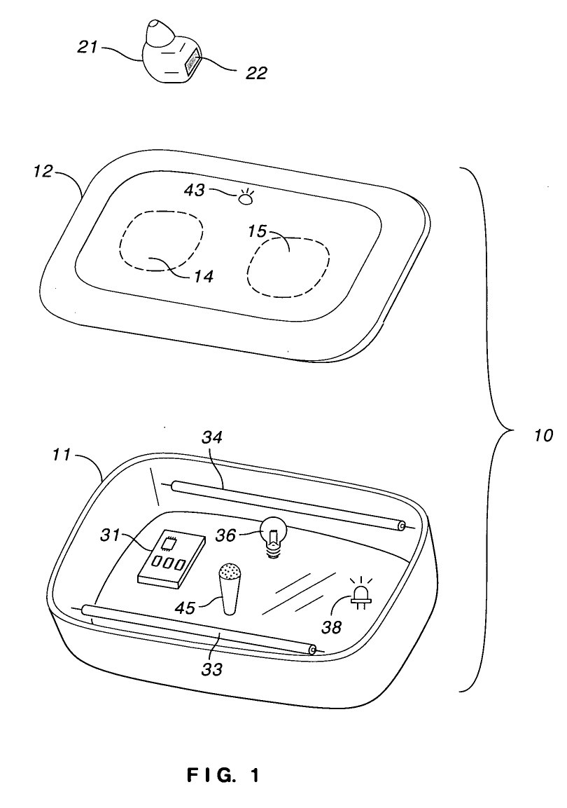

### BACKGROUND

This invention relates to a maintenance station that disinfects, dries, and recharges hearing aids using light.

Hearing aids powered by a battery have been known for almost a century; see U.S. Pat. No. 1,219,411 (Williams), for example. Modern technology has increased battery life greatly, yet it is annoying to have to replace batteries. Rechargeable batteries are a partial solution but require removal of the hearing aid and placement in a charger. Unless a user has two sets of hearing aids, the charging can be inconvenient.

Hearing aids having rechargeable batteries have been known in the art for a long time; e.g., see U.S. Pat. No. 3,297,933 (McCarthy). The trade-off between rechargeable batteries and non-rechargeable batteries is the inconvenience of having to replace the battery. There is also a trade-off in capacity. A non-rechargeable battery lasts much longer than a rechargeable battery having the same outside dimensions as the non-rechargeable battery. The similarity in shape and dimensions can and does cause confusion among users. The industry has adopted color codes on packaging to distinguish batteries but the problem persists.

The inconvenience of having to remove the battery from a hearing aid initially applied both to rechargeable batteries and non-rechargeable batteries. The sole advantage of rechargeable batteries was not having to be replaced. Then, chargers were developed that made electrical contact with the hearing aid, obviating the need to remove the rechargeable battery; e.g. see U.S. Pat. No. 3,493,695 (Stork). This simplified matters for those lacking the dexterity to remove and insert a battery. Having exposed electrical contacts is undesirable and inductive chargers solved this problem; e.g. see U.S. Pat. No. 4,379,988 (Mattatall).

Inductive chargers have their own set of difficulties, including adequate coupling between the primary inductor in the charger and the secondary inductor in the hearing aid; e.g. see U.S. Pat. No. 6,658,124 (Meadows). Even with adequate coupling, rechargeable batteries are not a panacea.

Using light to recharge the battery in a hearing aid is disclosed in U.S. Pat. No. 5,210,804 (Schmid) and U.S. Pat. No. 5,253,300 (Knapp). In the Schmid patent, a photovoltaic cell is behind a semi-transparent door in a hearing aid. The cell does not recharge the battery during use. At night, the door is opened and the hearing aid is placed in a stand that illuminates the photovoltaic cell. In the Knapp patent, the solar cell is external to the hearing aid, part of a recharging case.

It is known in the art to provide a chamber for drying hearing aids; U.S. Pat. No. 5,852,879 (Schumaier). A UV (germicidal) lamp is disclosed in a separate chamber for purifying recirculating air and the hearing aid. U.S. Pat. No. 7,182,820 (Campbell et al.) discloses apparatus for drying a hearing aid in combination with, in separate embodiments, a host of other functions; e.g. ionizer, vibrator, centrifuge, or charger. It is also disclosed that power for the hearing aid cleaning apparatus can be a solar cell and rechargeable batteries. Published application 2007/0207071 (Silverman et al.) discloses a hearing aid dehumidifier and disinfectant chamber.

The ordinary and accepted meaning of “translucent” is capable of transmitting light but causing sufficient diffusion to eliminate perception of distinct images. As used herein, “translucent” means capable of transmitting more than fifty percent of light incident normal to a surface. Thus, “translucent” includes media that is transparent.

In view of the foregoing, it is therefore an object of the invention to provide a maintenance station that disinfects, dries, and recharges hearing aids using light.

Another object of the invention is to provide a maintenance station that optionally provides optical communication with a hearing aid.

### SUMMARY OF THE INVENTION

The foregoing objects are achieved by this invention in which a maintenance station includes means for disinfecting, drying, recharging, and communicating with one or more hearing aids using light. In a preferred embodiment of the invention, a fluorescent lamp is primarily for disinfecting a hearing aid, an incandescent lamp is primarily for recharging a hearing aid, and a light emitting diode is primarily for communicating with a hearing aid. All power dissipated within the station aids in drying the hearing aids within.

### BRIEF DESCRIPTION OF THE DRAWINGS

A more complete understanding of the invention can be obtained by considering the following detailed description in conjunction with the accompanying drawings, in which:

The FIGURE is an exploded view of a preferred embodiment of the invention with a hearing aid.

### DETAILED DESCRIPTION OF THE INVENTION

In the FIGURE, maintenance station 10 includes a housing having base 11 and cover 12 of suitable shape and volume for containing one or more hearing aids and the apparatus for providing maintenance. Cover 12 optionally includes apertures 14 and 15 that can receive hearing aids and hold them in sockets (not shown) attached to the cover. The housing is opaque to ultraviolet radiation.

Hearing aid 21 includes photovoltaic cell 22 on or in the case thereof. If within, the photovoltaic cell is located adjacent a translucent portion of the case. Photovoltaic cell 22 provides power for hearing aid 21 and for charging a battery (not shown) within hearing aid 21.

Base 11 includes circuit board 31 for operating the maintenance station. Lamp 33 and lamp 34 are preferably miniature cold cathode fluorescent lamps (CCFL), such as commercially available from JKL Components Corporation. Lamp 36 is preferably an incandescent lamp. At least one of lamps 33 and 34 emits ultraviolet light, i.e. there is no phosphor in the lamp. Ultraviolet light having a wavelength of 100-280 nm. is known as UVC radiation and disinfects. To a small degree, the power dissipated in lamps 33 and 34 warms a hearing aid within base 11.

Lamps 33 and 34 are quantum emitters, not black body radiators. That is, even with phosphor, lamps 33 and 34 do not emit a continuous spectrum of light, as does an incandescent lamp. Rather, lamps 33 and 34 emit light in a plurality of narrow bands or spectral lines. Photovoltaic cell 22 may not convert efficiently at some wavelengths and charging may take longer than with a full spectrum source. Thus, what is known in the art as a multi-junction photocell is preferred for cell 22. A multi-junction photocell absorbs preferentially at several wavelengths. Lamps 33 and 34 can provide at least a trickle charge for a battery in a hearing aid.

Incandescent lamp 36 emits in a continuous spectrum, including a substantial amount of heat (infra red radiation) that warms a hearing aid within base 11, directly by absorption and indirectly by conduction, heating the air within base 11 (with cover 12 in place). A low voltage automotive lamp is suitable for lamp 36.

LED 38 is significantly faster than either a fluorescent lamp or an incandescent lamp in turning on and off and can be obtained in almost any desired wavelength. In accordance with another aspect of the invention, LED 38 is used for communicating with hearing aid 21 by way of photocell 22. LED 38 is optically coupled to photocell 22 when hearing aid 21 is contained within base 11 or is held in place in a socket in cover 12.

Even with a lamp on and charging a battery within hearing aid 21, LED 38 can communicate with hearing aid 21 by modulating the amplitude of light incident on photovoltaic cell 22. If CCFL lamps 33 and 34 are on, the modulation can be high and easily detected because the emission from LED 38 can be in a different band from the emissions from lamps 33 and 34. If lamp 36 is on, the modulation is lower, e.g. 5-25%, but still detectable by hearing aid 21.

In operation, lamps 33 and 34 provide some heating, drying, and recharging and at least one of the lamps provides UVC radiation for disinfecting. Lamp 36 provides heating, drying, and recharging. LED 38 provides communication. Thus, all functions are obtained from light in base 11. Light emission is controlled by a programmed microprocessor and suitable peripheral circuitry on circuit board 31, such as a ballast circuit for lamps 33 and 34. Indicator or warning LED 43 is preferably included in cover 12 so the user knows when the maintenance station is in use, particularly when lamps producing UVC radiation are turned on. Electrical connections among the components is not shown for simplicity.

Communication is, in effect, over a serial, optical bus. Two way communication with a hearing aid is obtained from microphone 45. Hearing aid 21 responds to inquiries by transmitting tones from a speaker (not shown) in the hearing aid. Acoustic coupling within the maintenance station is more than adequate for the tones to be detected by microphone 45. The tones can represent charging status or other information or simply the acknowledgment that a command was received and recognized.

The invention thus provides a maintenance station that disinfects, dries, and recharges hearing aids using light. In accordance with another aspect of the invention, the maintenance station provides optical communication with a hearing aid.

Having thus described the invention, it will be apparent to those of skill in the art that various modifications can be made within the scope of the invention. For example, any light source can be used for communication. The data rates may be lower for some light sources than for others; e.g. an incandescent lamp would probably have the lowest data rate. An LED can modulate at a higher frequency than other light sources. A switch can be added that turns off UVC emitting lamps when cover 12 is opened. Base 11 has no opening as illustrated. Holes for ventilation or electrical access are not shown as they do not relate to the invention. Hearing aid 21 is an in-the-ear type of hearing aid. The invention is applicable to other types of hearing aids, such as behind-the-ear hearing aids. Communication and charging are separate functions and need not take place simultanously.

What is claimed as the invention is:

1. A maintenance station for a hearing aid that has a photovoltaic cell as part of the hearing aid, said station characterized in that the station includes means for disinfecting, drying, and recharging the hearing aid using light.

2. The maintenance station as set forth in claim 1 and further characterized by means for communicating with the hearing aid using light.

3. The maintenance station as set forth in claim 2 wherein said means for communicating includes a light emitting diode.

4. The maintenance station as set forth in claim 1 wherein said station includes a housing having a base and a cover, wherein the base and the cover contain said means.

5. The maintenance station as set forth in claim 4 wherein said means include a fluorescent lamp and an incandescent lamp.

6. The maintenance station as set forth in claim 1 and further including a microphone for converting sounds emitted by the hearing aid into an electrical signal.

7. A maintenance station for a hearing aid that has a photovoltaic cell as part of the hearing aid, said station characterized in that the station includes means for disinfecting, drying, recharging, and communicating with the hearing aid using light.

8. The maintenance station as set forth in claim 7 wherein said means include a fluorescent lamp and an incandescent lamp.

9. The maintenance station as set forth in claim 7 and further including a microphone for converting sounds emitted by the hearing aid into an electrical signal.
